(19) United States
(12) Patent Application Publication
(10) Pub. No.: US 2006/0080092 A1
(43) Pub. Date: Apr. 13, 2006

(54) Telecommunication device and method

(76) Inventor: Edward S. Sherman, Santa Rosa, CA (US)

Correspondence Address: EDWARD S. SHERMAN, ESQ., 3554 ROUND BARN BLVD., SUITE 303, SANTA ROSA, CA, 95403, US

(21) Appl. No.: 11/192,579

(22) Filed: Jul. 28, 2005

Related U.S. Application Data
(60) Provisional application No. 60/592,179, filed on Jul. 28, 2004.

(51) Int. Cl. G10L 21/02

(52) U.S. Cl. 704/226

(57) ABSTRACT

A method is disclosed to assist users of telecommunication equipment to improve the likelihood that the party receives and comprehends their speech. The method involves quantifying the quality of speech at both the point of reception and transmission, and then communicating this information to the transmitter who is speaking. To the extent that the background noise at the speaker or listener location is so large as to decrease the signal to noise ratio, or other parameter related to the comprehensibility of speech, to an unacceptable level the speaker may choose to reduce the background noise, or speak loader to increase the signal. Likewise, to the extent that the communication system itself generates unacceptable noise, the speaker may choose to speak loader to increase the signal. However, as the speaker is made aware of the quality of perception at the listener, they need not speaker loader than necessary for the listener to comprehend their speech.

### CROSS REFERENCE TO RELATED APPLICATIONS

The present application claims priority to the U.S. Provisional Patent Application for a “Telecommunication Device and Method”, having Ser. No. 60/592,179, filed on Jul. 28, 2004, which is incorporated herein by reference.

### BACKGROUND OF INVENTION

The present invention relates to methods of improving the quality of telephonic or radio duplex communications, in particular to communications having marginal comprehension quality due to background noise at the speaker or listener, signal degradation or distortions, and combinations thereof.

Speech coding is highly deployed in modern communication devices, although originally the evolution was driven specifically by the development of mobile phones. Due to the limited bandwidth, speech coding is a key element to “over air transmissions”. However, the encoded data when sent through the air by radio frequencies will be exposed to a sensitive transmission link, which is very likely to be affected by errors. Such errors may corrupt the transmitted data, and due to the lack of redundancy, it may be difficult if not impossible to reconstruct the speech signal. Due to interaction of speech coding and transmission, errors in a mobile transmission can cause heavy distortions that sound quite different from traditional “analog” distortions, making it difficult for the receiver to understand the information. In fact, the speaker is frequently unaware that the listener is having trouble hearing or understanding such speech, and may be constantly inquiring, “Do you hear mew?”

Further, the portability of device, such as phones and radios, that permit “over air transmissions” naturally include environments that are substantially noisier than the environments typical in traditional PSTN (Public Switched Telephone Network) or POTS (Plain Old Telephone System) usage. Such noisy environments include public social environments (restaurants, bars), automobile environments, public transportation environments (subways, trains, airports) and other common situations (shopping locations and city/traffic noise).

However real world use of cell phone is problematic even if system performance is flawless. Portability in effect, guarantees use in marginal environments, background noise pick up at speaker, background noise of listener, tendency to speak loudly, social consequences, confounding of system noise, low confidence of full comprehension

It is therefore a first object of the present invention to provide a method for the user to select their speaking environment and voice volume in proportion to the listener's requirements, as effected by their own listening environment as well as degradation from the system quality of service.

Another object of the invention is to provide one or more speakers with the ability to know if their voice is being heard at a high enough quality for the speaker to comprehend it.

### SUMMARY OF INVENTION

In the present invention, the first object is achieved by measuring background noise at the speaker, calculating the signal to noise ratio and indicating it to the speaker.

Other objectives achieved by measuring background noise at the receiver and transmitting the results of a signal to noise ratio analysis to at least one of the sender and receiver.

Another object is achieved by the communicating instructions to one or more parties to the conversation that indicate if the other party is likely to comprehend their communications, as well as suggest or signal behavior that would either improve the quality of the received communication such that it can be comprehended, or indicate that the voice may be lowered without detriment to the communication quality, thus avoiding the social consequences of speaking loader than necessary.

Accordingly, the inventive voice based communication methods and device disclosed herein have a signal processing module operative to receive, analyze and display the speech quality as received or transmitted via a metric such as a signal to noise ratio. The speaker has the option of adjusting their voice level and/or reducing background noise to improve the other party's quality of reception. Likewise, in a preferred embodiments at least one speaker can also receive a signal indicating the voice or sound quality as received, which in comparison to the quality metric for transmission indicate if the other party is likely to comprehend the speech, or the poor quality is due to transmission related factors independent of the speakers hearing or listening environment. In the latter case, the metric would indicate that transmission quality is unlikely to improve and that the connection should be repeated by other means, including a different time and place.

A further aspect of the invention is notifying the user of the results. The method of notification may be by visual indicates, such as digital or analog meter, text messages and the like. Other method of notification includes vibration, sounds and patterns of the same.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a block diagram illustrating the general operative principles and method of the present invention.

FIG. 2 is schematic diagram illustrating the operative principles in applying the instant invention for the benefit of the user.

FIG. 3 is another schematic diagram illustrating the operative principles in applying the instant invention for the benefit of the user.

FIGS. 4A, B and C are timing diagram illustrating various embodiment of notifying the user of the outcome of the processes illustrated in FIGS. 1, 2 and 3.

FIGS. 5 A, B and C are timing diagram illustrating various alternative embodiment of notifying the user of the outcome of the processes illustrated in FIGS. 1, 2 and 3.

FIG. 6 is a timing diagram illustrating an embodiment for transmitting the voice quality parameters, voice signal and optional test signals.

### DETAILED DESCRIPTION

As used in this disclosure, VQP is a figure of merit indicating deviations from perfect speech. Some threshold value of VQP correlates with the listener ability to readily and comfortable comprehend the speaker. Numerous methods have been developed to analyze voice signals to quantify the quality as it relates to final perception of the sound generated there from. Such methods, including the associated hardware and software are in fact in the configuration testing & maintenance of telecommunication systems. The VQP may be determined simply by determining the ratio of signal (voice) to background noise, or SNR for signal to noise ratio, and optionally takes into account the background noise at the listener as well as at the speaker. Mathematically speaking the signal to noise ratio as received is equal to the spoken signal divided by the sum of the noise due to: the speakers background, the listeners background and the system noise, it being understood that the SNR is a transient property having temporal variation. The VQP may also take into account of noise and distortion related to the quality of transmission of the signal, or deploy a combination of parameter. More sophisticated methods of determining a VQP have been primarily developed measure performance of a telecommunication system, or the analog to digital conversion Codec's used therein, as disclosed in the following U.S. patents, which are incorporated herein by reference: U.S. Pat. Nos. 6,628,453; 6,330,428; 6,418,196; 6,609,092; 6,275,797; 5,987,320, which are incorporated herein by reference.

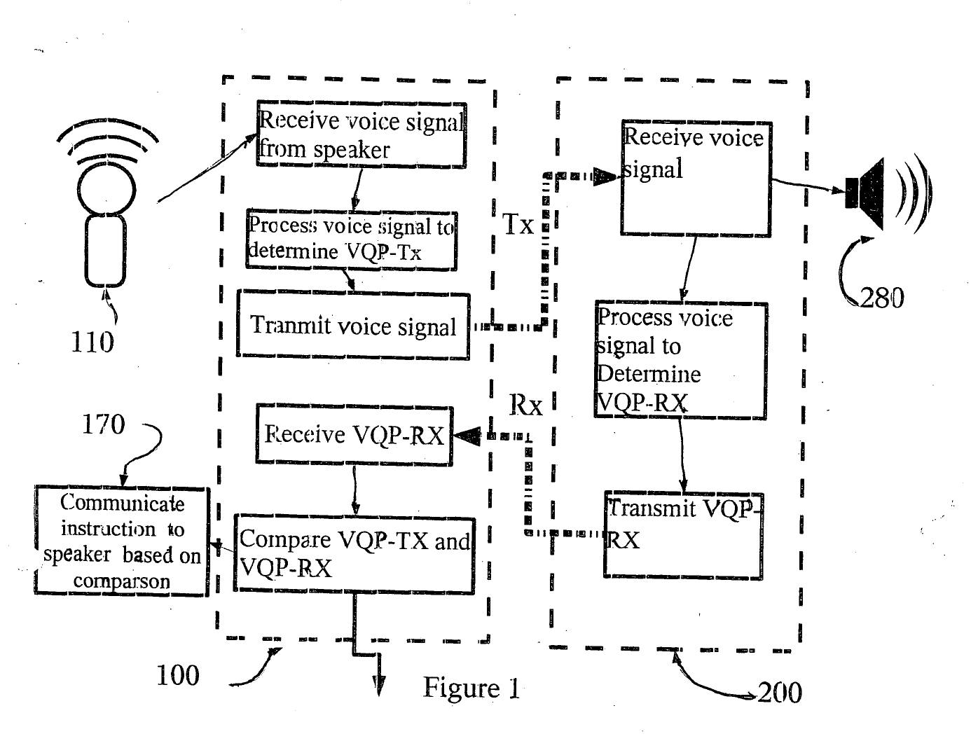

In accordance with the present invention, FIG. 1 illustrates the general operative principles of one embodiment of the present invention. In a conversation between two transceivers, the first transceiver 100 receives a signal arising from sound that includes the user's voice as detected by a first microphone transducer 110. The first transceiver processes the signal to determine the Voice Quality Factor of the signal as transmitted (VQF-Tx) as well as the usual function of encoding or digitizing the signal for transmission (as Tx or a portion thereof) according to an ITU or other standard protocol, such as code division multiplexing, time division multiplexing, voice over IP (VoIP) protocol and the like. Tx is received by the second transceiver 200, and converted to an analog signal that is amplified and broadcast as sound from speaker transducer 280, with the intention intended to represent the voice detected by microphone 110. It should be appreciated that the digital signal as transmitted is unlikely to be identical with the digital transmission as received, due to signal, loss and distortion during transmission, and or the application of compression and decompression algorithms due to bandwidth limitations of the communication system. The second transceiver 200 also processes the voice signal to determine a Voice Quality Parameter (VQP) for the signal as received (VQP-Rx). The second transceiver, in addition to transmitting voice detected by its own microphone(s) (not shown) transmits the VQP-Rx as signal Rx, which is then received by first transceiver 100. The first transceiver performs various functions to compare and analyze the differences between VQP-Tx and VQP-Rx, ultimately communicating information or instruction to the user 170 based on such analysis and comparison.

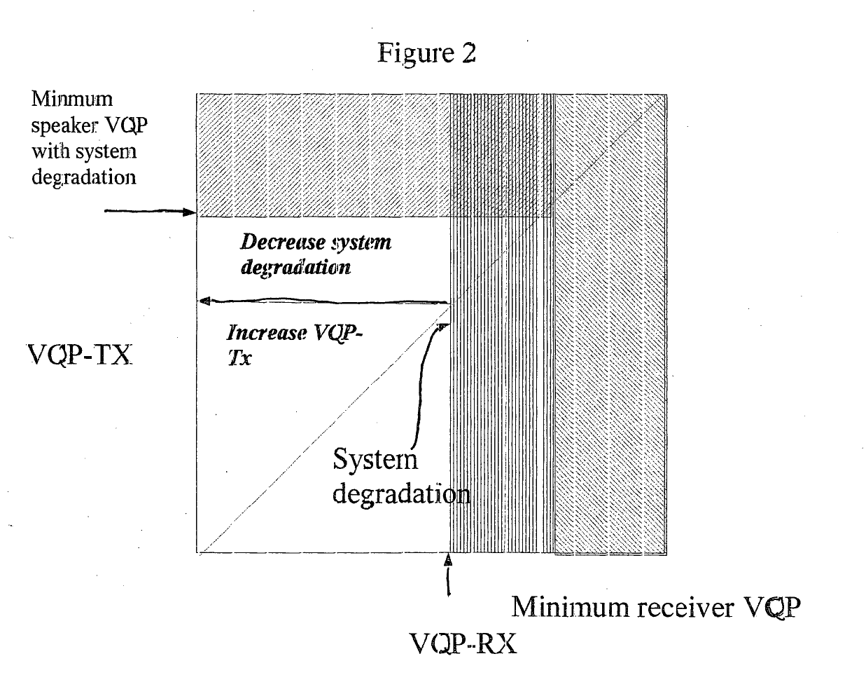

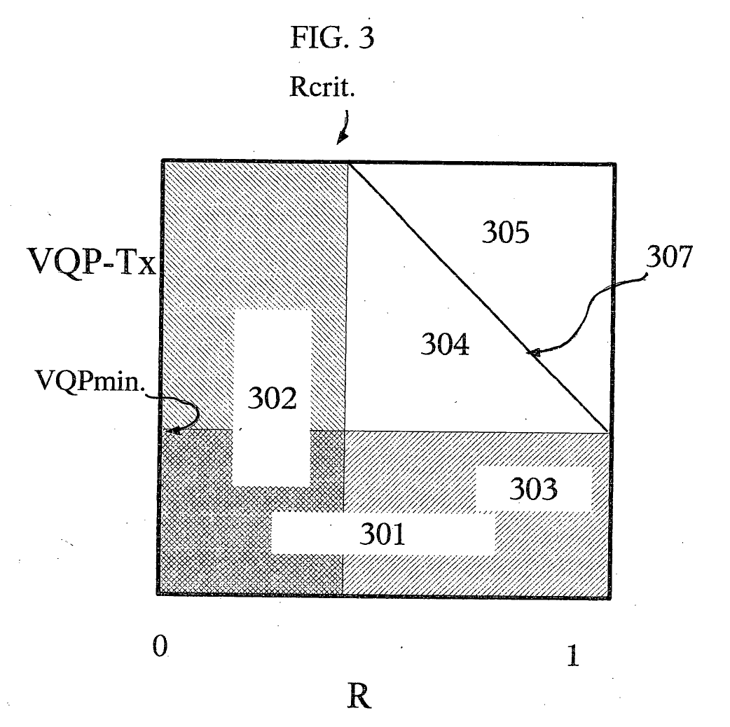

However, transmitting both voice signals and characteristics of the speech quality as transmitted, along with other signals depends on the specific embodiment of the invention. As will be further discussed with respect to FIG. 2 and FIG. 3, it is desirable to quantify the difference between VQP-Tx and VQP-Rx as a Total Quality Parameter (TQP), which is communicated and available to both the speaker and listener. Ideally, the TQP as a figure of merit describing and taking into account the speakers listening conditions, which is background noise that would affect their ability to hear incoming voice signals when amplified through the transceivers speaker. The TQP also describes and takes into account the noise and/or distortion characteristics in the transmitted signal as well as the background noise in the speaker's environment, which is eliminated, but is picked up by the transceivers microphone, amplified and transmitted to the receiver/listener. The receiving transceiver, in the preferred embodiment, is able to analyze the characteristics of the speech quality as received, and then transmit this information back to each speaking party as a TQP.

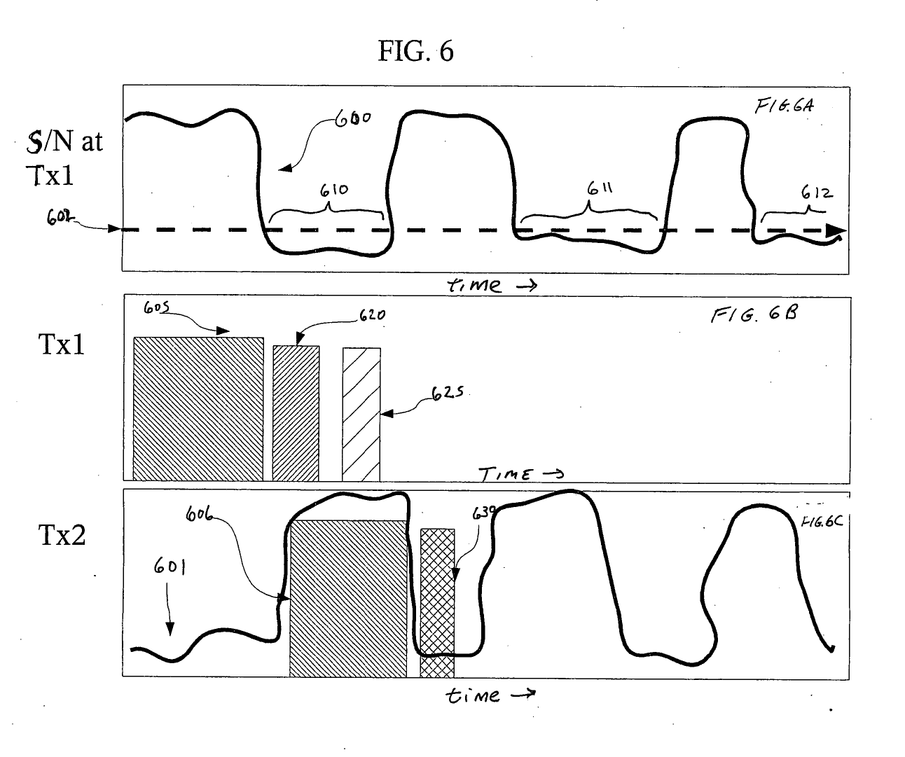

A currently favored method of determining a VQP is the PESQ method. PESQ is described in an IEEE publication entitled “Perceptual Evaluation of Speech Quality (PESQ)A New method for speech quality assessment of telephone networks and Codecs”, by A. W. Rix et al., ICASASSP, 7-11 May 2001, which is incorporated herein by reference. PESQ is not used on real speech, but rather known test waveforms (or test waveforms plus real noise); a second point of novelty, more fully described with respect to FIG. 6, includes interlacing the test waveforms with the real speech when a mobile or cell phone would not normally transmit. As the cell phone has an internal S/N discriminator to make this decision, it simply transmits test waveforms (or PESQ results) with an appropriate packet header that is used by the receiving phone before releasing the channel back to the network. Of course, PESQ could be continuous if an additional channel is allocated such as instant messaging or picture transmission, but possibly not representative.

FIG. 2 illustrates operative principles in applying and using the analysis and comparison of VQP-Tx and VQP-Rx. In the ideal situation, the VQP-Tx is very high, that is there is no background noise picked up by microphone 110. Thus, if no noise addition or signal distortion occurs in converting the signal between various electronic and digital formats in both the first and second transceiver, including the conversion back to sound, then VQP-Rx should be high, and the same as VQP-Tx.

However, real world communications suffer from background noise picked up microphone 110 (i.e. other conversations in a restaurant, air conditioner and fan noise in a car, or traffic noises), noise and distortion in transmission, as well as the difficulty of listener discerning the sound generated by speaker 280 due to background noise in their environment. At some level of VQPmin. a listener is simply unable to consistently understand what is being said. This value of VQPmin. is indicated by the arrow point to a minimum speaker threshold on the y-axis of the graph in FIG. 2. Thus, even if the transmission to the receiver is perfect VQP-Tx must be equal to or above VQPmin. Thus, one aspect of the invention is indicating the speaker or user of the first transceiver 100 is if there speech can be perceived even with perfect transmission. For example, a user of first transceiver 100 in a noisy environment would want to speak loud enough such that their speech signal to noise ratio is increased to improve VQP-Tx to above the minimum level. However, if the user is in a restaurant, they might want to speak not more loudly than necessary so that VQP-Tx is at the minimum level. However, as many communication systems are not perfect, and may vary with the locations of the users, network traffic and other conditions it is ultimately important to know if what the speaker hears is greater than VQPmin. Thus, transmitting VQP-Rx to the speaker provides a means of notifying them that what the listener actually receives and hear is comprehensible. In the most preferred embodiment of the invention, VQP-Rx also takes into account background noise heard by the listen, which can be extracted from the signal picked up by one or more microphones at the second transceiver.

FIG. 3 illustrates further the operative principle in applying the ratio, R, between VQP-TX and VQP-RX, and re-plotting the graph in FIG. 2 with VQP-Tx on the x-axis and R on the Y-axis. The ratio R (R=VQP-Rx/VQP-Tx) can never be greater than one, so the x-axis is scaled from zero to one. A horizontal line extending from VQPrnin. on the y-axis defines a region 301 below this line. To the extent that the analysis characterizes the TQP within region 301 communication is not possible as VQP-TX is less than VQPmin.

It should be appreciated from the foregoing discussion that as VQP-Rx is the critical parameter for the listener greater degradation of signal quality and/or noise from the communication system, represented by a lower value of R, requires a higher value of VQP-TX. However, as VQP-Tm cannot be increased beyond a certain level, thus at some level of R, defined as Rcrit. A vertical line extending downward from Rcrit. defines region 302 to the right of this line. To the extent that the analysis characterizes the total quality parameter (TQP) within region 302 communication is not possible as VQP-TX is less than VQPmin.

When the TQP is within regional 305, defined as lying above diagonal line 307, VQP-Rx is within the comprehensible range. Although regions 301 and 302 overlap it should be appreciated that a sub-portion of region 301 that does not fall within 302, denoted as 303, is significant, as it is possible to obtain an acceptable VQP-RX that is moving into region 305, by first increasing VQP-Tx to some value above VQPmin., that is placing the TQP beyond region 304, that is crossing line 307 as one increases VQP-Tx.

Thus, in preferred embodiment, the user is instructed on the options to reach region 305, based on either having the speaker go to a quieter environment that is decreasing noise, speaking loader to increase signal, or having the listener go to a quieter environment. Therefore, in the most preferred embodiment, both the speaker and listener receive notification and recommendations to improve the TQP such that VQP-Rx is within the comprehensible range.

However, it should be recognized that at some point, increasing TCP-Tx VQP by the user becomes fruitless as the noise or degradation to VQP by the communication system cannot be overcome, such as when one is one the edge of cell phone coverage area, or transmission is blocked or distorted by building or geography. In one zone, the worst case, the ratio between background noises, arising from the system, to signal sound is so low that no increase in the signal volume improves comprehension, as the signal is in effect distorted by the system.

In yet another aspect of the invention, algorithms/ methods could be used continuously on the real speech, to interpolate between the test waveform packets. As to commercial acceptance, one issue (among no doubt many) is the typical delay and frequency of update available, which must be within seconds to be of practical use to the consumer. This will depend on the sample waveform length and the amount of time to send the sample waveform in an interlaced format, and process the PESQ and/or other algorithms. A further advantage of the invention in its various embodiments is that it alerts users to the need and opportunity to change equipment speech or system/network quality problems unlikely to be overcome by speaking loader, or changing the speaking or listening environment. For example the VQP information transmitted to either the speaking or receiving party may be used to select a quality of service level from the communication carrier, and hence bandwidth allocation, as taught in U.S. Pat. No. 6,418,196. Alternatively, the user may choose to hold or complete a call using POTS as opposed to VoIP or a mobile communication system.

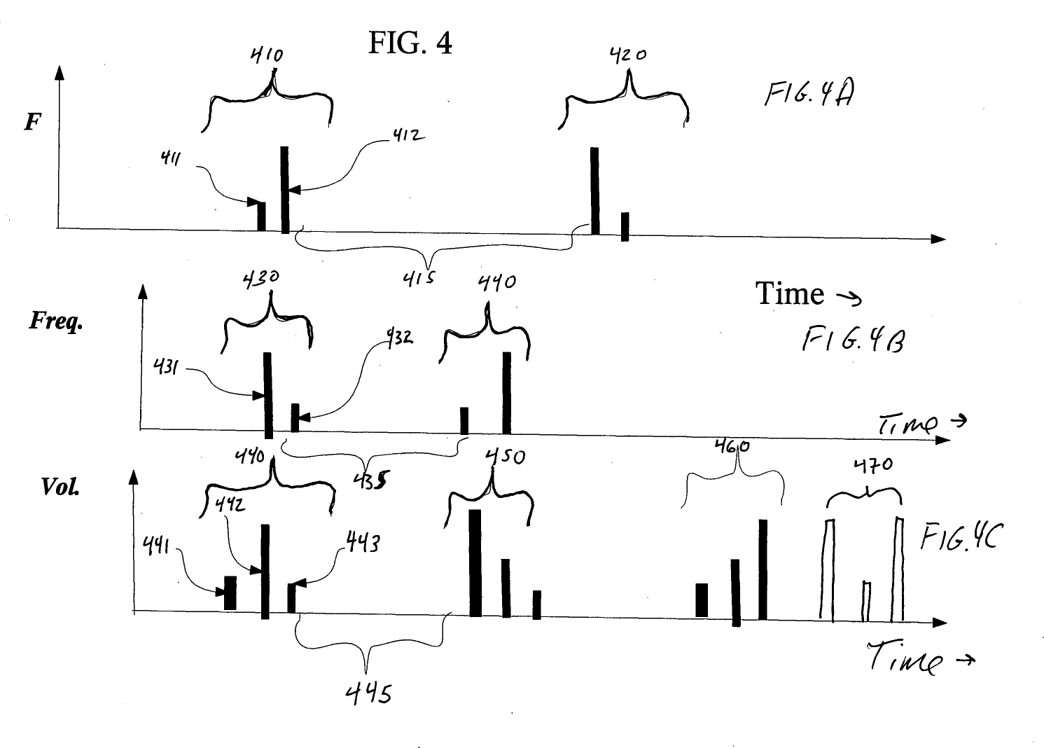

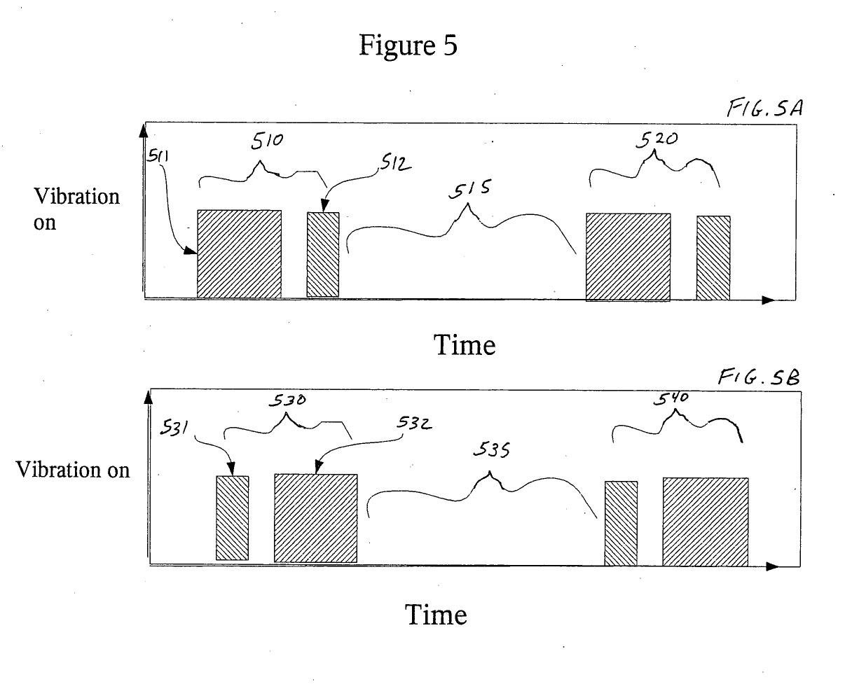

FIG. 4 and FIG. 5 illustrate various alert methods to notify users of the VQP-Rx, and hence alert speaker to marginality & sufficiency of their speech, and thus suggest changes in behavior. Such alert methods include, without limit, vibration and the like.

In FIG. 4, timing diagrams illustrate alternative methods of sound signal indicating voice quality to at least one of the users. Time is plotted on the x-axis, with the signal parameter on the y-axis. In FIG. 4A, “F” represents the time that a tone, or for visual signals a light, is applied or in the “on” state, that is signal packet 410 comprise a short duration tone 411 followed by a longer duration tone 412. Signal packet 420 is the opposite, a long duration tone followed by a short duration tone. Signal packet 410 might be used to indicate that the user should increase their voice volume, as VQP-Rx is below a critical threshold corresponding to TQP in region 303 or 304 in FIG. 3. In contrast, signal packet 420 might signal the user to optionally decrease their voice volume, as the VQP-Rx is sufficient, with the TQP safely within region 305 in FIG. 3. Note that a gap 415 exists between the clusters of tones of difference duration.

In FIG. 4B “freq.” represents the frequency of the sound tone presented to the user. The tones are on for an equal length of time, but varying in frequency to indicate the recommended conduct consistent with the options to move within region 305 in FIG. 3. A gap 435 exists between the clusters of tones of difference frequency. The gap may be of fixed duration, or decrease to provide a signal packet as often as necessary to provide a warning, or assurance that the system is functioning and that the listener has received comprehensible sound. Signal packet 430 comprise a low pitch tone 431 followed by a higher pitch tone 432. Signal packet 440 is the opposite, a higher pitch tone followed by a lower pitch tone. Signal packet 420 might be used to indicate that the user should increase their voice volume, as VQP- Rx is below a critical threshold corresponding to TQP in region 303 or 304 in FIG. 3. In contrast, signal packet 430 might signal the user to optionally decrease their voice volume, as the VQP-Rx is sufficient, with the TQP safely within region 305 in FIG. 3.

In FIG. 4c, the “Vol.” represents the volume of the sound in a sequence of indicating pulses heard by the user. The first signal packet 440 comprises 3 tones, 441, 442 and 443, that increase, from 441 to 442, then decrease in volume, in 443. In contrast, signal packet 450 comprises three tones that steadily decrease in volume. Thus, signal packet 440 might indicate that the TQP, VQP-Tx or VQP-Rx signal is adequate. The second group 450 of three tones decreasing in volume might be used to indicate that the speaker's voice could be lowered, whereas the signal packet 460 of three tones of increasing volume might indicate that the speaker should raise their voice volume. In the last signal packet, 470 a lower volume tone sandwiched between two louder tones might indicate that the system noise is too great to overcome by any changes in behavior. Note that a gap 445 exists between the first signal packet 440 and the second signal packet 450. The spacing of the signal packets, or gap time duration, can be uniform, or increase or decrease to indicate any of the parameters previously mentioned or described herein.

It should be further understood that any of the diagrams in FIGS. 4A, 4B and 4C can also form a two-dimensional visual display to communicate similar information to that explained herein with respect to FIG. 2 and FIG. 3

FIG. 5A indicates a similar communication scheme as FIG. 5 using a vibrator. The vibrator may be an accessory or build into the communication device. Positive values on the y-axis merely illustrates if the vibrator is on, while the x-axis denotes the elapsed time. Thus, in FIG. 5A, a first signal packet 510 comprises a first short duration vibration 511, followed by a time gap and longer duration vibration 1512. After time gap 515, a second signal packet of vibration pulses is applied. The spacing of the gap 515 can be uniform, or increase or decrease to indicate any of the parameter previously mentioned or described herein. In signal packet the short and long duration vibrations are revered in order, indicating a change in status with respect to the TQP, or instructions to the user, as described with respect to any of the signal packets in FIG. 4 A, B or C.

In contrast, FIG. 5B, signal packets 530 and 540 both comprises the same pattern of vibration 531 and 532, of short and then longer duration respectively, thus indicating that the TQP status has not changed, and or is within a specific realm corresponding to the option that correspond to the different region in FIG. 3, discussed above.

Independent of displaying the information to the user, as described with respect to FIG. 4 and FIG. 5, TQP/VQP can be determined and transmitted substantially continuously, such as by a parallel channel or path, for example an email or instant messaging function of a mobile telephone or related communication device, or encoded in channels used in call routing, Further, such information can be encoded as extra bits in the digital voice channel.

Alternatively, the TQP/VQP can be determined either continuously or discontinuously, but transmitted discontinuously by temporal sample coding when the speech is not being transmitted. Such methods of determining the VQP may include or utilize the interlacing of non-intrusive test waveforms, such as test speech patterns used in the PESQ protocol.

For example, as shown in FIG. 6, the timing diagram illustrates one such embodiment for transmitting the TQP/VQP and voice signal. FIG. 6A illustrates the speech signal to noise ratio that would normally be determined in the microprocessor of a mobile phone to determine when to transmit speech, labeled 600. When the SNR drops below a threshold, 602 indicated by the dashed vertical line, voice is usually not transmitted, the channel being released for use by another party. However, the mobile phone, rather than releasing this channel can use the gaps, such as 610, 611 and 612, between speech, can use the gap to transmit VQF-Tx 620, and optionally a referral text signal 625. thus FIG. 6B shows a corresponding timing for transmitting the digitized speech signal 605, VQF-Tx 620, and optionally a referral text signal 625.

FIG. 6C overlays the transmitted signal of the second party, 601, with the transmitted digital signals that communicate the VQP as received to the speaker using the first transceiver, whose transmission is shown in FIG. 6B. Thus, during the normal speech block, digitized voice 606 is transmitted, however, during the noise block, when the

The system of FIG. 6 is particularly preferred as it allows the exchange of VQP information without creating a new communication protocol in the system, or using additional channel, as the communication device can internally override the system control by transmitting signal such as 620, 625 and 630 as if they are voice, with sufficient encryption of start and stop coding such that the receiver does not interpret it as voice, but recognizes that it is VQP information, and processes or transmits it in accordance with FIG. 1 and the related diagrams in FIGS. 2 and 3 as necessary.

Further, part or all of analysis of the signal information to determine the TQP/VQP can occur in either or both telecommunication devices, or reside in part or in whole within the communication network. In other embodiments, the user may be able to choose among a number of methods to determine the TQP/VQP, depending on how frequently they want to be updated during the conversation. Alternatively, the system may select an algorithm most appropriate to the temporal nature and variation in the noise characteristics

In various embodiments, background noise levels are detected using the microphone, an extra sensor that is coupled to the device for sensing environmental noise, and by indirect measures such as the position of a volume control knob, or an indication of a location of use of the device. It should be understood that the determination and transmission of TQP/VQP between the speaker and listener is optional duplex, and is not limited to the methodology illustrated with FIGS. 2 and 3.

The above invention can be implemented in numerous methods, which for example include providing the integrated function disclosed herein with the microprocessor of a mobile telephone. Alternatively, a user may deploy a module that receives the signal through the auxiliary output jack or split line connection of any phone and merely notify the speaker of the current, as transmitted VQP. In other embodiments, the invention may be implemented as a software routine running on a general-purpose computer to analyze the TQP/VQP of communications using the voice over internet protocol (VoIP) from point to point, in which the signal is digitally transmitted over network, such as the internet, between one or more users via the computer.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A method of communication, the method comprising:
a) providing a first transceiver,
b) providing second transceiver,
c) converting a speakers voice to a first digital signal,
d) transmitting the first digital signal to second transceiver,
e) receiving the first digital signal at the second transceiver, from the first transceiver, as a second digital signal,
f) converting the second digital to sound,
g) analyzing at least one of voice, first and second digital to deriver a first voice quality parameter,
h) transmitting the first voice quality factor to the second transceiver.

2. The method of claim 1 further comprising the step of comparing the first and second voice quality parameters to derive a total quality parameter.

3. The method of claim 2 further comprising the step of communicating at least one of a voice quality parameter and a total quality parameter to at least one of the first and second transceivers.

4. The method of claim 1 further comprising the step of determining if speaker should increase volume of speech to improve at least one of the voice quality parameters and the total quality parameter.

5. The method of claim 1 further comprising the step of determining if speaker should decrease background noise to improve at least one of the voice quality parameters and the total quality parameter.

6. The method of claim 1 further comprising the step of determining background noise.

7. The method of claim 1 further comprising the step of calculating a minimum received voice quality parameter.

8. The method of claim 1 wherein the voice quality factor is transmitted to the second receiver as a digital signal on the same channel used for the digital voice signal.

9. The method of claim 1 further comprising the steps of transmitting a test signal and analyzing the test signal to determine at least one voice quality parameter.

10. The method of claim 9 wherein the test signal is transmitted on the same channel as the digitized voice signals.

11. The method of claim 9 wherein the test signal is transmitted as a series of packets interlaced with the digitized voice signals.

12. The method of claim 11 wherein the voice quality parameter is interpolated during the time intervals between when the test signal is interlaced with the digitized voice signals.

13. The method of claim 9 wherein at least portions of the voice quality parameter is derived from both the test signal and at least one of the voice, first and second digital signals.

14. A method of communication, the method comprising:
a) providing a transceiver having a first transducer for receiving a speakers voice and a second transceiver for receiving background noise,
b) converting a speakers voice from the first transducer to a first digital signal,
c) converting the background noise received at the second transceiver to a second digital signal,
d) analyzing the signals detected by the first and second transducers derive a voice quality parameter,
e) transmitting at least the first digital signal to a second transceiver,
f) transmitting the voice quality factor to the second transceiver.

15. A mobile communication device having means for:
a) converting a speakers voice to a first digital signal,
b) transmitting the first digital signal to a second mobile communication device,
c) receiving a second digital signal from a second mobile communication device, where the second digital signal is converted from a speakers voice,
d) converting the second digital to sound,
e) analyzing at least one of voice, first and second digital signals to derive a first voice quality parameter.

16. A mobile communication device according to claim 15 wherein the mobile communication device further comprises means for transmitting the first voice quality factor to the second mobile communication device.

17. A mobile communication device according to claim 15 further comprising means to transmit a test signal between the first and second mobile communication device and analyze the test signal to derive a second voice quality parameter.

18. A mobile communication device according to claim 17 wherein the test signal is transmitted on the same channel as the voice signal.

19. A mobile communication device according to claim 17 wherein at least portions of one of the first and second voice quality parameter is derived from both the test signal and at least one of the voice, first and second digital signals.

20. A mobile communication device according to claim 17 wherein the voice quality parameter is interpolated from the modulations of at least one of the voice, first and second digital signals between time intervals wherein test signals are transmitted and analyzed.
